(19) United States
(12) Patent Application Publication
(10) Pub. No.: US 2004/0058299 A1
(43) Pub. Date: Mar. 25, 2004

(54) Prosthetic construct and methods for its manufacture and use

(76) Inventors: Mattias Molin, Stockholm (SE); Karl Ekstrand, Saltsjobaden (SE)

Correspondence Address: Michael R Ward, Morrison & Foerster, 425 Market Street, San Francisco, CA, 94105-2482, US

(21) Appl. No.: 10/415,694

(22) PCT Filed: Oct. 31, 2001
(86) PCT No.: PCT/SE01/02387

(30) Foreign Application Priority Data
Nov. 3, 2000 (SE) 0004033-7

(51) Int. Cl. A61C 13/00; A61C 13/12

(52) U.S. Cl. 433/167; 433/172

(57) ABSTRACT

A pre-fabricated, mouldable composite body, e.g. a body (12) forming elongate apertures (12, 14, 15, 16) for receiving and engaging metallic fastening means for attachment to osseointegrated fixtures. A composite polymer bridge for dental implants is manufactured by attaching suitable fastening means (10) on the abutments that penetrate the gingiva or on their replicas in a positive model (11) of the jaw and placing a mouldable body, e.g. a body (12) forming elongate apertures (13, 14, 15, 16) around these means. The mouldable body is then pressed together to collapse the elongate apertures and to fit tightly around the fastening means, whereupon the body is cured.

The present invention concerns a novel prosthetic device, its composition and methods for its production and use. The invention relates in particular to supporting structures for use in dental prosthesis and dental reconstructive surgery.

### BACKGROUND OF THE INVENTION

Periodontitis or teeth loss is a serious medical problem, highly disabling for those affected. In industrialised countries, the increased life-expectancy leads to an increased number of elderly patients without their own teeth, and in developing countries, teeth loss is common also among relatively young persons. Reconstructive dental surgery and dental prosthetic devices are also often necessary for victims of car accidents, who often suffer from skull and jaw fractures and facial injury.

Osseointegrated dental implants have been used for more than thirty years with good clinical results. In reconstructive dental surgery, titanium fixtures are arranged in the maxillae (upper jaw) and/or the mandible (lower jaw), with specially designed abutments projecting through the gingival tissue. A supporting structure or so called bridge which carries the artificial teeth is attached to these abutments, for example with gold or titanium screws and specially designed titanium cones, fitting into the previously mentioned abutments.

A dental implant can thus be divided into three structural components; the titanium fixtures integrated to the jawbone, the support structure or bridge including fastening means for attaching to the osseointegrated fixtures, and the functional and aesthetic superstructure including artificial teeth and gums.

The standard structure for an implant-fixed bridge prosthesis has since many years been a gold framework with resin veneers. Gold has the advantage of being well tolerated by the body, but the disadvantages of a high cost and considerable weight. Alternative materials include titanium, which can be either cast or machined to its final shape, and polymeric materials, which are moulded onto a gypsum impression of the jaw. The polymeric structures have the advantage of being both lighter and less costly than the metallic structures. The polymeric structures are however still cumbersome to manufacture, and as they are subjected to considerable forces and mechanical stress in the mouth, they need to fulfil high technical requirements.

### PRIOR ART

Fibre reinforced polymer dental bridges have been developed not only in order to decrease the weight and cost of traditional bridges, but also to simplify their production. In the article “Implant-fixed dental bridges from carbon/graphite fibre reinforced poly (methyl methacrylate)” in Biomaterials 1986, Vol. 7, page 73-75, a method for preparing bridges from carbon/graphite reinforced poly (methyl methacrylate) on titanium implants is described. According to this method, an impression is made of the jaw, and a positive gypsum model with abutment copings is cast from the impression. Titanium cones for attachment of the bridge to the osseointegrated fixtures in the jaws of the patient are then fixed to the abutment copings or replicas on the model. Following this, carbon/graphite fibres are braided around the titanium cones and embedded in polymer.

This method is further described in the Swedish patent SE 457 691, including the features of delivering a fibre bundle in a tube, cutting a suitable length of the packaged fibre bundle and wetting it with a suitable matrix, e.g. acrylic plastic. The composite polymer is then pressed into a mould. According to a preferred embodiments, the fibre bundle is perforated with a sharp object to form perforations or holes in places corresponding to the location of the abutment copings immediately prior to moulding and pointed guides are placed on the fastening means to facilitate their introduction into the perforations.

The manufacture of a fibre reinforced polymer dental support structure or bridge still requires considerable skill and involves many steps, regardless of the presently available devices. Further, the easy, cost-efficient and fail-safe manufacture is an important requirement for the wider introduction of the technique to patients on a global scale.

### SUMMARY OF THE INVENTION

The above defined problems are solved by a composite polymer body and methods of its use according to the attached claims, i.a. by making available a pre-fabricated, mouldable composite polymer body. According to one embodiment of the invention, the body forms elongate apertures for receiving and engaging fastening means for attachment to osseointegrated fixtures. This body can be substantially bar-shaped or adapted to the form of the upper or lower jawbone of a patient, e.g. substantially horse shoe shaped. The elongated apertures can be provided in the form of one aperture, extending partially or substantially along the entire length of the body, or two or more separate apertures. According to an embodiment of the invention, the body engages at least one fastening means in at least one elongated aperture, whereupon the body is moulded or pressed together, collapsing the at least one aperture around at least one fastening means. Then the body is cured and may then be used as such or as a support structure or bridge for a dental prostethic device.

### SHORT DESCRIPTION OF THE DRAWINGS

The invention will be described in closer detail in the following description and drawings, in which

FIG. 1 shows three alternative embodiments of the object according to the present invention, an elongate structure forming two elongate apertures (A), one elongate aperture (B) and a multitude of apertures (C);

FIG. 2 shows three alternative embodiments of the object according to the present invention, a structure adapted to the upper or lower jaw of a human patient, forming three elongate apertures (A), one single elongate aperture (B) and a multitude of apertures (C); and

FIG. 3 shows how a structure according to FIG. 2 A is attached to fixtures protruding from a gypsum model of the upper or lower jaw of a human patient.

### DESCRIPTION

The present invention solves the above problems by making available a pre-fabricated, mouldable composite polymer body, which according to one embodiment forms apertures for receiving and engaging fastening means for attachment to osseointegrated fixtures. Preferably said apertures are elongate apertures.

A composite polymer bridge for dental implants according to the invention is manufactured by attaching suitable fastening means on the abutments that penetrate the gingiva or on their replicas in a positive model of the jaw and placing the mouldable body around these means. The mouldable composite polymer body is either pressed down, forcing the fastening means to penetrate the body, or placed with the fastening means fitting into apertures present in the composite polymer body. When placing the fastening means into the apertures, the body is then pressed together to collapse the elongate apertures and to fit tightly around the fastening means, whereupon the polymer or polymer mixture of the mouldable body is cured, rendering it hard and workable. The attaching to the fastening means and optionally also the curing can be performed in situ, in the mouth of the patient, further reducing the time and steps required for prosthesis manufacture.

The mouldable composite polymer body, according to an embodiment of the present invention, forms at least one elongated aperture for receiving at least one fastening means for attachment to an osseointegrated fixture. The mouldable composite polymer body can also be without apertures, having only notches or minor indentions, for receiving the fastening means, or having a flat surface, possible to penetrate in optional locations, as desired or necessitated by the placement of the abutments in the patient's jaw or on the model of the jaw.

The body is preferably substantially bar-shaped or horse shoe-shaped.

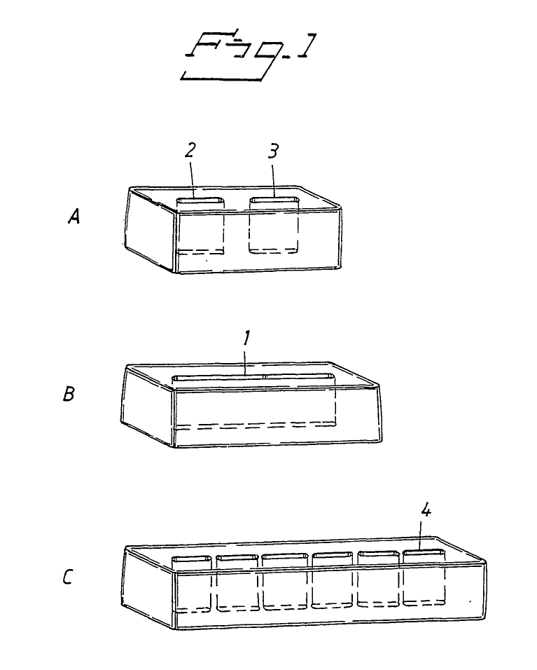

According to one embodiment, the body is substantially bar-shaped as shown in FIG. 1, forming one elongate aperture (1) for receiving at least one fastening means for attachment to an osseointegrated fixture. The body forms, according to another embodiment of the invention, two or more elongate apertures (2, 3 and 4) for receiving two or more fastening means for attachment to an osseointegrated fixture. The apertures can have an identical shape or different shapes, e.g. one slightly longer and one slightly shorter elongate aperture. The aperture/-s can be shaped to accommodate a specific type of fastening means, but is/are preferably shaped to accommodate all available fastening means, which means are then securely attached to the body by collapsing the aperture/-s, making the body fit tightly around the fastening means.

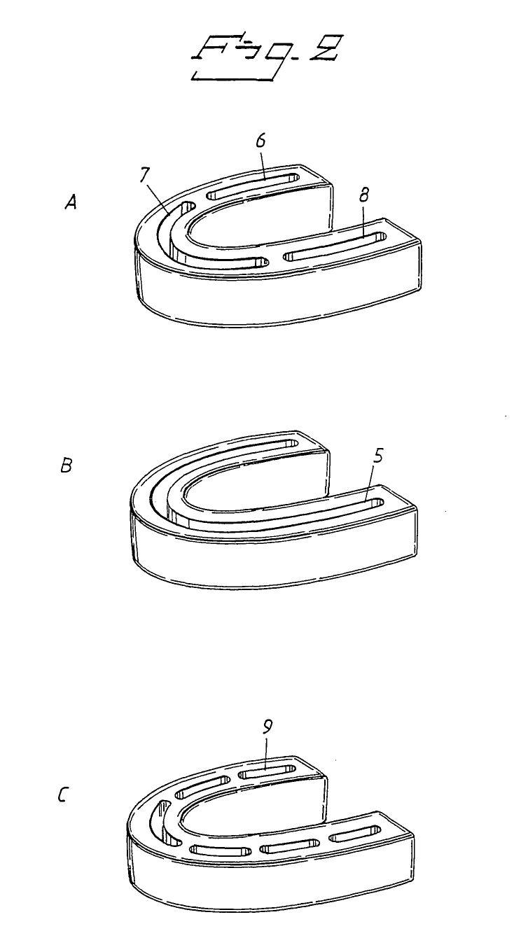

According to a preferred embodiment, the mouldable composite body is substantially horse shoe-shaped as shown in FIG. 2, forming one elongate aperture (5) for receiving at least one fastening means for attachment to an osseointegrated fixture. It may also form two or more elongate apertures (6, 7, 8 and 9 ) for receiving two or more fastening means for attachment to an osseointegrated fixture. The apertures can have an identical shape or different shapes, e.g. one slightly longer (7) and two slightly shorter elongate apertures (6, 8).

The mouldable body in un-cured form comprises a mixture of at least one monomer, crosslinking agent and inhibitor. The monomer and crosslinking agent are preferably chosen among the following compounds: poly(vinylchloride-co-vinylacetate), methyl methacrylate, ethylene glycol dimethacrylate, poly methylene methacrylate, butane-diol-dimethacrylate, and dibenzoyl peroxide or a mixture thereof. The inhibitor is e.g. p-hydroquinone or monomethylated p-hydroquinone.

According to a preferred embodiment, the body is fibre reinforced, e.g. reinforced with fibres chosen among: carbon/graphite fibres, glass fibres, aromatic polyamide fibres, such as Kevlar® fibres, and polyester fibres, such as Mylar® fibres.

The present invention also makes available a method for the manufacture of dental bridges for a human patient, comprising:

attaching at least one fastening means to a positive model of the upper or lower jaw of a patient in a position corresponding to the position of an osseointegrated fixture in the jaw of the patient,

placing a mouldable polymer body over the mould, the fastening means penetrating the polymer body,

optionally compressing the mouldable body sufficiently to secure the fastening means in its position within said polymer body, and

curing the polymer body.

An embodiment of the present invention also makes available a method for the manufacture of dental bridges for a human patient, comprising:

attaching at least one fastening means to a positive model of the upper or lower jaw of a patient in a position corresponding to the position of an osseointegrated fixture in the jaw of the patient,

placing a mouldable polymer body forming at least one elongate aperture over the mould, the fastening means fitting into the elongate aperture,

compressing the mouldable body sufficiently to secure the fastening means in its position within said polymer body, and

curing the polymer body.

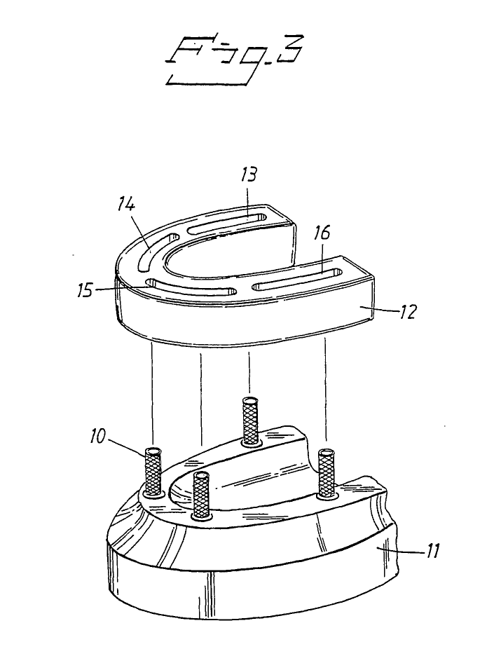

This latter method is schematically illustrated in FIG. 3, where a four fastening means (10) are shown, attached to a positive model (11), and a horse shoe-shaped body (12), having apertures (13, 14, 15, and 16) in the process of being placed on the model (11), the apertures engaging the fastening means. The figure also illustrates how the composite body can accommodate the fastening means irrespective of their exact positions. The horse shoe shaped body is only one example, the bar shaped or a partial, horse shoe shaped or slightly bent body can also be used.

According to the invention, the mouldable body is manually compressed, e.g. pinched or slightly kneaded to fit tightly around the fastening means.

According to an embodiment of the invention, the composite polymer body is heat cured, e.g. in a water bath, holding a temperature necessary for curing the polymer or polymer mixture, preferably boiling water. According to another embodiment of the invention, the polymer or polymer mixture is light cured, preferably using UV-light or daylight.

The method for the manufacture of dental bridges for a human patient can also be performed more or less in situ, in the mouth of the patient, and according to one embodiment the method comprises:

attaching at least one fastening means to an osseointegrated fixture in the jaw of the patient,

placing a mouldable polymer body in the mouth of the patient, the fastening means penetrating into the polymer body,

compressing the polymer body sufficiently to secure the fastening means in its position within said polymer body, and

curing the polymer body.

The method for the manufacture of dental bridges for a human patient can also be performed more or less in situ, in the mouth of the patient, and according to another embodiment the method comprises:

attaching at least one fastening means to an osseointegrated fixture in the jaw of the patient,

placing a mouldable polymer body forming at least one elongate aperture in the mouth of the patient, the fastening means fitting into the elongate aperture,

compressing the polymer body sufficiently to secure the fastening means in its position within said polymer body, and

curing the polymer body.

When the polymer body is cured in situ, in the mouth of the patient, it is preferred that the polymer is light cured, e.g. using UV-light or daylight. Alternatively, the polymer is cured at temperature near normal or slightly above normal body temperature.

After curing the polymer, regardless of this taking place in the mouth of the patient or outside, for example in a water bath, holding a temperature necessary for curing the polymer or polymer mixture, the aesthetic and functional superstructure is built on the supporting structure or the bridge, using conventional methods.

The inventive mouldable body has the advantages of being pre-fabricated and easy to use. The bar shape and in particular the horse-shoe shape requires very little or no working to fit or adjust to the jaw of the patient and is virtually independent of how the osseointegrated fixtures and the corresponding fastening means are arranged in the jaw. This makes the inventive mouldable body very convenient to use, as it is easily adapted to different patients and different configurations of the prosthetic devices. The bar shaped body can be cut in suitable lengths but is preferably delivered in two or more different lengths and widths, if desired. A bar shaped polymer body is then used for partial prosthetic devices, for example for replacing the incisors only, the molars and premolars on one side only or different prosthetic constructs, short of being full jaw dentures.

Easy application is the main advantage of the horse-shoe shaped mouldable body. The horse-shoe shaped body can be cut and bent as desired or may be delivered in two or more different sizes and widths. Further, it constitutes a light, strong and relatively inexpensive construct, compared to metallic bridges.

The inventive method has the advantage of speed and ease of operation, compared to prior art methods. The reduced number of steps and the easier use gives economical benefits and makes possible a wider use of dental reconstruction. Both the bar-shaped and the horse-shoe shaped polymer body have the additional advantage of making possible first aid repairs in case of dentures breaking and having to be removed for repair. A temporary bridge having perfect fit can be manufactured/installed also by less qualified personnel, not requiring the skills of a dentist, physician or dental technician. The cured polymer body itself can in these cases function as rudimentary teeth until the patient's prosthetic device is repaired or a new constructed.

The inventive mouldable body is thus suitable for first aid and replacement use in hospitals, centres for the elderly, in isolated communities, in military and in sports applications, only to mention a few examples.

Although the invention has been described with regard to its preferred embodiments, which constitute the best mode presently known to the inventors, it should be understood that various changes and modifications as would be obvious to one having the ordinary skill in this art may be made without departing from the scope of the invention as set forth in the claims appended hereto.

1. A mouldable composite body comprising a curable monomer mixture, characterized in that said body is suitable for receiving at least one fastening means for attachment to an osseointegrated fixture.

2. A mouldable composite body according to claim 1, characterized in that said body forms at least one elongated aperture for receiving at least one fastening means for attachment to an osseointegrated fixture.

3. A mouldable composite body according to claim 1, characterized in that said body (1B) is substantially bar-shaped, forming one elongate aperture (1) for receiving at least one fastening means for attachment to an osseointegrated fixture.

4. A mouldable composite body according to claim 1, characterized in that said body (1A, 1C) is substantially bar-shaped, forming two or more elongate apertures (2, 3, 4) for receiving two or more fastening means for attachment to an osseointegrated fixture.

5. A mouldable composite body according to claim 1, characterized in that said body (2B) is substantially horse shoe-shaped, forming one elongate aperture (5) for receiving at least one fastening means for attachment to an osseointegrated fixture.

6. A mouldable composite body according to claim 1, characterized in that said body (2A, 2C) is substantially horse shoe-shaped, forming two or more elongate apertures (6, 7, 8, 9) for receiving two or more fastening means for attachment to an osseointegrated fixture.

7. A mouldable composite body according to any one of claims 1 through 6, characterized in that said body is made from a fibre reinforced polymer.

8. A mouldable composite body according to claim 7, characterized in that the fibres are chosen among: carbon/graphite fibres, glass fibres, aromatic polyamide fibres, such as Kevlar® fibres, and polyester fibres, such as Mylar® fibres.

9. A mouldable composite body according to claim 7, characterized in that said body comprises a monomer chosen among the following: poly(vinylchloride-co-vinylacetate), methyl methacrylate, ethylene glycol dimethacrylate, poly methylene methacrylate, and dibenzoyl peroxide or a mixture thereof.

10. Method for the manufacture of dental bridges for a human patient, comprising:
attaching at least one fastening means (10) to a positive model (11) of the upper or lower jaw of a patient in a position corresponding to the position of an osseointegrated fixture in the jaw of the patient,
placing a mouldable composite body (12) forming at least one elongate aperture (13, 14, 15, 16) over the model (11), and the at least one fastening means fitted into an elongate aperture,
compressing the composite body (12) sufficiently to secure the fastening means (10) in its position within the body, and
curing the composite body (12).

11. Method for the manufacture of dental bridges for a human patient, comprising:
attaching at least one fastening means (10) to a positive model (11) of the upper or lower jaw of a patient in a position corresponding to the position of an osseointegrated fixture in the jaw of the patient,
placing a mouldable composite body (12) over the model (11), forcing the at least one fastening means to penetrate into the body,
compressing the composite body (12) sufficiently to secure the fastening means (10) in its position within the body, and
curing the composite body (12).

12. Method according to one of claims 10-11, characterized in that the composite body is heat cured.

13. Method according to one of claims 10-11, characterized in that the composite body is light cured, preferably using UV-light or daylight.

14. Method for the manufacture of dental bridges for a human patient, comprising:
attaching at least one fastening means to an osseointegrated fixture in the jaw of the patient,
placing a mouldable composite body in the mouth of the patient, forcing said at least one fastening means to penetrate into the composite body,
compressing the composite body sufficiently to secure the fastening means in its (their) position within the body, and
curing the composite body.

15. Method for the manufacture of dental bridges for a human patient, comprising:
attaching at least one fastening means to an osseointegrated fixture in the jaw of the patient,
placing a mouldable composite body forming at least one elongate aperture in the mouth of the patient, the fastening means fitted into the elongate aperture,
compressing the composite body sufficiently to secure the fastening means in its (their) position within the body, and
curing the composite body.

16. Method according to one of claims 14-15, characterized in that the composite body is heat cured at a temperature near or slightly above normal body temperature.

17. Method according to one of claims 14-15, characterized in that the composite body is light cured, preferably using UV-light or daylight.
